(19) United States
(12) Patent Application Publication
(10) Pub. No.: US 2025/0353476 A1
(43) Pub. Date: Nov. 20, 2025

(54) ELECTRIC BRAKING DEVICE

(71) Applicant: ADVICS CO., LTD., Kariya-shi, Aichi-ken (JP)

(72) Inventors: Yasutoshi KITAHARA, Kariya-shi, Aichi-ken (JP); Naru SUGIMOTO, Kariya-shi, Aichi-ken (JP); Satoshi HIRATA, Kariya-shi, Aichi-ken (JP)

(73) Assignee: ADVICS CO., LTD., Kariya-shi, Aichi-ken (JP)

(21) Appl. No.: 18/879,888

(22) PCT Filed: Jul. 4, 2023
(86) PCT No.: PCT/JP2023/024710

§ 371 Date: Dec. 30, 2024

(30) Foreign Application Priority Data
Jul. 4, 2022 (JP) 2022-107613

(51) Int. Cl. B60T 8/17; B60T 13/74

(52) U.S. Cl. CPC B60T 8/17; B60T 13/746

(57) ABSTRACT

An electric braking device includes a transmission mechanism including an input gear configured to input rotation of a motor shaft member and an output gear configured to be rotatable in response to rotation of the input gear and transmit the rotation to an actuator unit. The electric braking device includes a circuit unit including a circuit board and mounting components mounted on the circuit board. In the electric braking device, the circuit board and an electric motor are disposed such that a virtual plane parallel to the circuit board intersects an axial direction of the motor shaft member. In the electric braking device, the output gear is disposed so as to intersect a specific plane P2 that is a plane passing through the circuit unit among virtual planes parallel to the circuit board.

### TECHNICAL FIELD

The present disclosure relates to an electric braking device.

### BACKGROUND ART

Patent Literature 1 discloses an electric braking device including an electric motor, a piston that presses a friction material against a rotary body, and a linear motion conversion mechanism that converts rotation of the electric motor to a linear motion of the piston. The electric braking device includes an ECU including an ECU cover attached to an outside of a housing and an ECU board accommodated between the housing and the ECU cover. The ECU is disposed at a position orthogonal to an axis extending along a rotation axis of the electric motor.

### CITATION LIST

### Patent Literature

PTL 1: KR10-2021-0004895A

### SUMMARY

### Technical Problem

In the electric braking device in which the ECU is attached to the outside of the housing as disclosed in PTL 1, there is a problem that the electric braking device is increased in size by an amount corresponding to the ECU cover in a direction extending along the rotation axis of the electric motor.

### Solution to Problem

An electric braking device for solving the above problem includes: an electric motor configured to rotate a motor shaft member, an actuator unit configured to move a friction material in response to rotation of the motor shaft member in the electric motor, and generate a braking force on a wheel of a vehicle by pressing the friction material against a rotary body that rotates integrally with the wheel; a transmission mechanism configured to transmit a rotary motion of the motor shaft member to the actuator unit, and including an input gear configured to input the rotation of the motor shaft member, and an output gear configured to rotate in response to rotation of the input gear and transmit the rotation to the actuator unit; and a circuit unit configured to control the electric motor, and including a circuit board and a mounting component mounted on the circuit board. The circuit board and the electric motor are disposed such that a virtual plane parallel to the circuit board intersects an axial direction of the motor shaft member, and the output gear is disposed to intersect a specific plane which is a plane that passes through the circuit unit among the virtual planes.

According to the above configuration, the output gear is disposed so as to intersect with the specific plane that passes through the circuit unit among the virtual planes parallel to the circuit board, so that the output gear and the circuit unit overlap in the axial direction of the motor shaft member intersecting with the virtual plane. Due to this overlap, a size of the electric braking device in the axial direction of the motor shaft member is unlikely to increase.

### BRIEF DESCRIPTION OF DRAWINGS

FIG. 1 is a partial cross-sectional view showing an embodiment of an electric braking device.

FIG. 2 is a schematic diagram showing the electric braking device.

FIG. 3 is a schematic diagram showing an electric braking device according to a modification.

FIG. 4 is a schematic diagram showing an electric braking device according to another modification.

FIG. 5 is a schematic diagram showing an electric braking device according to another modification.

FIG. 6 is a schematic diagram showing an electric braking device according to still another modification.

### DESCRIPTION OF EMBODIMENTS

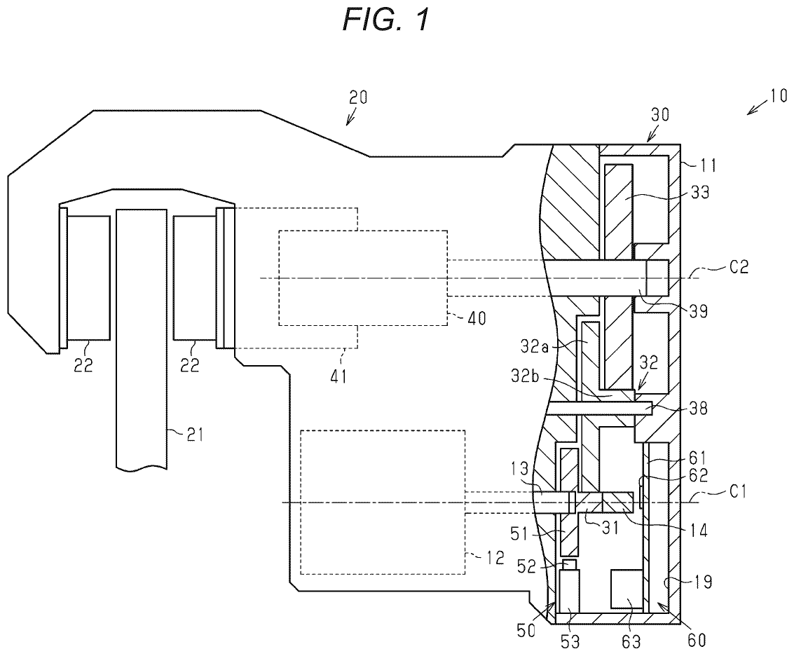

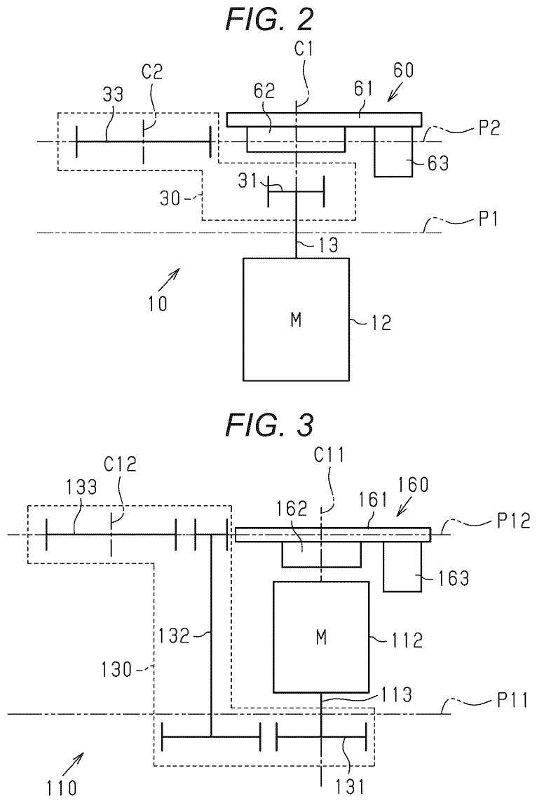

Hereinafter, an electric braking device 10 as an embodiment of an electric braking device will be described with reference to FIGS. 1 and 2.

### Electric Braking Device

The electric braking device 10 includes an electric motor 12 that rotates a motor shaft member 13. The electric braking device 10 includes an actuator unit 20 that can move a friction material 22 in response to the rotation of the motor shaft member 13 in the electric motor 12, and generates a braking force on a wheel of a vehicle by pressing the friction material 22 against a rotary body 21 that rotates integrally with the wheel. The electric braking device 10 includes a transmission mechanism 30 that transmits a rotary motion of the motor shaft member 13 to the actuator unit 20. The transmission mechanism 30 includes an input gear 31 that inputs the rotation of the motor shaft member 13, and an output gear 33 that is configured to be rotatable in response to rotation of the input gear 31 and transmits the rotation to the actuator unit 20. The electric braking device 10 includes a circuit unit 60 that controls the electric motor 12 and includes a circuit board 61 and mounting components mounted on the circuit board 61.

In the electric braking device 10, the circuit board 61 and the electric motor 12 are disposed such that a virtual plane parallel to the circuit board 61 intersects an axial direction of the motor shaft member 13. In the electric braking device 10, the output gear is disposed so as to intersect a specific plane P2 that is a plane passing through the circuit unit 60 among virtual planes parallel to the circuit board 61.

FIG. 1 shows the electric braking device 10. The electric braking device 10 includes a housing 11. The electric braking device 10 includes the actuator unit 20.

The actuator unit 20 includes the friction material 22 that can be pressed against the rotary body 21 that rotates integrally with the wheel of the vehicle. The rotary body 21 is, for example, a brake disk. The actuator unit 20 can generate a larger braking force as a force pressing the friction material 22 against the rotary body 21 becomes larger.

The electric braking device 10 includes the electric motor 12. In FIG. 1, a line along an axis of the motor shaft member 13 of the electric motor 12 is indicated as a rotation axis C1. A direction in which the rotation axis C1 extends coincides with the axial direction of the motor shaft member 13. That is, the axial direction of the motor shaft member 13 means both directions extending along the axis of the motor shaft member 13.

The actuator unit 20 includes a conversion mechanism 40 that converts the rotary motion of the electric motor 12 into a linear motion. The conversion mechanism 40 is, for example, a feed screw including a screw shaft and a nut. The actuator unit 20 includes a piston 41 to which the friction material 22 is attached at an end portion facing the rotary body 21. The actuator unit 20 can move the piston 41, that is, the friction material 22, by the linear motion obtained by the conversion mechanism 40 converting the rotary motion of the electric motor 12. One of directions in which the piston 41 is moved by the linear motion is a direction in which the friction material 22 attached to the piston 41 approaches the rotary body 21. The other one of the directions in which the piston 41 is moved by the linear motion is a direction in which the friction material 22 attached to the piston 41 is separated from the rotary body 21.

The actuator unit 20 includes the transmission mechanism 30 that transmits the rotary motion of the electric motor 12 to the conversion mechanism 40. The transmission mechanism 30 may include a speed reduction mechanism. An example of the transmission mechanism 30 will be described.

As shown in FIG. 1, the transmission mechanism 30 is implemented by a combination of gears and the like. The transmission mechanism 30 includes the input gear 31. The input gear 31 is attached to the motor shaft member 13. The transmission mechanism 30 includes the output gear 33. The transmission mechanism 30 includes an output shaft member 39. The output gear 33 is attached to the output shaft member 39.

The transmission mechanism 30 may include an intermediate gear 32. The transmission mechanism 30 may include an intermediate shaft member 38 to which the intermediate gear 32 is attached. For example, the intermediate gear 32 includes a first gear portion 32a that can engage with the input gear 31 and a second gear portion 32b that can engage with the output gear 33. In the intermediate gear 32, the first gear portion 32a and the second gear portion 32b integrally rotate. In an example of the intermediate gear 32, as shown in FIG. 1, the first gear portion 32a and the second gear portion 32b are integrally formed. For example, the transmission mechanism 30 may include a first intermediate gear corresponding to the first gear portion 32a that can engage with the input gear 31, and a second intermediate gear corresponding to the second gear portion 32b that can engage with the output gear 33. The plurality of intermediate gears may be attached to the intermediate shaft member 38.

In the transmission mechanism 30, the rotation of the motor shaft member 13 is input to the input gear 31. The output gear 33 can rotate in response to the rotation of the input gear 31. The output gear 33 transmits the rotation to the actuator unit 20 via the output shaft member 39. More specifically, the rotary motion of the electric motor 12 can be transmitted from the motor shaft member 13 to the intermediate shaft member 38 by the engagement between the input gear 31 and the first gear portion 32a of the intermediate gear 32. The rotary motion of the electric motor 12 can be transmitted from the intermediate shaft member 38 to the output shaft member 39 by the engagement between the second gear portion 32b of the intermediate gear 32 and the output gear 33. The output shaft member 39 is coupled to the conversion mechanism 40. The rotary motion is transmitted to the conversion mechanism 40 by the output gear 33 rotating the output shaft member 39. In FIG. 1, a line along an axis of the output shaft member 39 is indicated as an output axis C2.

Although one intermediate gear 32 is shown as an example in FIG. 1, in the transmission mechanism 30, a plurality of gears contributing to the transmission of the rotary motion may be interposed between the input gear 31 and the output gear 33.

As shown in FIG. 1, the electric braking device 10 may include a braking force maintenance mechanism 50. The braking force maintenance mechanism 50 can maintain the braking force applied by the actuator unit 20. For example, the braking force maintenance mechanism 50 functions as a ratchet mechanism.

An example of the braking force maintenance mechanism 50 will be described. The braking force maintenance mechanism 50 includes a ratchet gear 51 attached to the motor shaft member 13. For example, the ratchet gear 51 is formed integrally with the input gear 31. As another example, the ratchet gear 51 may be attached to the motor shaft member 13 separately from the input gear 31. The braking force maintenance mechanism 50 includes an engagement portion 52 and an actuator 53. The engagement portion 52 has a pawl shape that engages with teeth of the ratchet gear 51. The actuator 53 can engage the engagement portion 52 with the ratchet gear 51. The braking force maintenance mechanism 50 can prevent the ratchet gear 51 from rotating by engaging the engagement portion 52 with the ratchet gear 51. The braking force maintenance mechanism 50 can maintain the braking force by preventing the ratchet gear 51 from rotating. The braking force maintenance mechanism 50 can release the maintenance of the braking force by releasing the engagement between the engagement portion 52 and the ratchet gear 51.

The electric braking device 10 includes the circuit unit 60. The circuit unit 60 includes a processing circuit that controls the rotary motion of the electric motor 12. The circuit unit 60 includes the circuit board 61 and the mounting components mounted on the circuit board 61. For example, the circuit unit 60 is accommodated in the housing 11. FIG. 1 shows an example in which the circuit unit 60 is attached such that the rotation axis C1, which is the line along the axis of the motor shaft member 13, intersects the circuit unit 60. More specifically, the circuit unit 60 is disposed such that the rotation axis C1 and the circuit board 61 are orthogonal to each other.

The electric braking device 10 may include a heat conduction member for radiating heat from the circuit unit 60. For example, the heat conduction member can be attached while in contact with the circuit unit 60 and the housing 11 so as to be interposed between the circuit board 61 and the housing 11.

### Circuit Unit

FIG. 1 shows a small-sized mounting component 62 as the mounting component included in the circuit unit 60. The small-sized mounting component 62 is a component having a low height from a surface of the circuit board 61. As shown in FIG. 1, the circuit unit 60 may include a large-sized mounting component 63 as the mounting component. The large-sized mounting component 63 is a component having a relatively high height from the surface of the circuit board 61.

The mounting components included in the circuit unit 60 may be mounted on either one surface or the other surface of the circuit board 61. FIG. 1 shows an example in which the small-sized mounting component 62 and the large-sized mounting component 63 are mounted on the surface of the circuit board 61 that faces the electric motor 12.

Examples of the large-sized mounting component 63 include a connector, a heat sink, and a capacitor. Specific examples of the connector include a header, a socket, and a plug.

The small-sized mounting component 62 is, for example, a sensor unit in a rotation angle sensor for detecting a rotation angle of the motor shaft member 13. FIG. 1 shows an example in which a magnet 14, which is a detection target constituting the rotation angle sensor, is attached to the motor shaft member 13. In this case, the small-sized mounting component 62 is disposed at a position facing the magnet 14 as shown in FIG. 1. Other examples of the small-sized mounting component 62 include a chip resistor and an integrated circuit to be mounted on the surface.

### Transmission Mechanism

The transmission mechanism 30 included in the electric braking device 10 will be described in more detail.

As shown in FIG. 1, the input gear 31, the intermediate gear 32, and the output gear 33 are cylindrical gears. The motor shaft member 13, the intermediate shaft member 38, and the output shaft member 39 are disposed such that the axis of the motor shaft member 13, an axis of the intermediate shaft member 38, and the axis of the output shaft member 39 are parallel to one another.

As shown in FIG. 1, the intermediate gear 32 is attached such that the second gear portion 32b is positioned at a position farther from the electric motor 12 than the first gear portion 32a in an axial direction of the intermediate shaft member 38. That is, the output gear 33 is attached at a position farther from the electric motor 12 than the input gear 31 in the axial direction of the motor shaft member 13. In other words, the gears included in the transmission mechanism 30 are disposed to engage with each other such that the input gear 31 and the output gear 33 are aligned in order from the electric motor 12 in the axial direction of the motor shaft member 13.

As shown in FIG. 1, in the axial direction of the motor shaft member 13, an accommodating portion 19 defined in the housing 11 for accommodating the circuit unit 60 is provided in a direction on an opposite side of the electric motor 12 from the input gear 31. The accommodating portion 19 defined in the housing 11 is provided in a direction approaching the electric motor 12 from the conversion mechanism 40 with respect to the output gear 33.

### Arrangement of Circuit Unit

A positional relationship among the circuit unit 60, the transmission mechanism 30, and the electric motor 12 will be described in detail with reference to FIGS. 1 and 2. FIG. 2 schematically shows the electric braking device 10. In FIG. 2, the configuration of the transmission mechanism 30 is omitted except for the input gear 31 and the output gear 33.

In FIG. 2, a two-dot chain line representing a virtual plane P1 is shown. The virtual plane P1 is a virtual plane parallel to the circuit board 61 and intersecting the motor shaft member 13. That is, in FIG. 2, of virtual planes parallel to the circuit board 61, one plane that intersects with the motor shaft member 13 is shown as the virtual plane P1.

FIG. 2 shows a two-dot chain line representing the specific plane P2. The specific plane P2 is a virtual plane parallel to the circuit board 61 and passing through the circuit unit 60. For example, the specific plane P2 is a virtual plane that passes through the mounting components without passing through the circuit board 61 of the circuit unit 60. An example of the specific plane P2 is a virtual plane passing through the large-sized mounting component 63 of the circuit unit 60. The specific plane P2 may be a virtual plane passing through the small-sized mounting component 62 of the circuit unit 60.

A positional relationship between the circuit unit 60 and the output gear 33 will be described.

In the electric braking device 10, the output gear 33 is disposed so as to intersect the specific plane P2. In other words, the mounting components and the output gear 33 are disposed on the specific plane P2. For example, the output gear 33 is disposed such that a surface of the output gear 33 orthogonal to the axis of the output shaft member 39 is parallel to the circuit board 61. In this case, as shown in FIG. 2, the output axis C2 is orthogonal to the specific plane P2. In this case, the output gear 33 can be disposed such that the surface of the output gear 33 orthogonal to the axis of the output shaft member 39 is on the specific plane P2.

The output gear 33 does not face the circuit unit 60 in the direction in which the output axis C2 extends. That is, a size of the circuit board 61 included in the electric braking device 10 is a size allowing the circuit board 61 and the output gear 33 not to face each other in the direction in which the output axis C2 extends.

The output gear 33 preferably does not protrude to a position farther from the electric motor 12 than the circuit board 61 in the direction from the input gear 31 toward the circuit unit 60 in the axial direction of the motor shaft member 13.

A positional relationship between the circuit unit 60 and the input gear 31 will be described.

In the electric braking device 10, the input gear 31 is disposed at a position shifted in the axial direction of the motor shaft member 13 with respect to the circuit board 61. For example, the electric motor 12, the input gear 31, and the circuit board 61 are disposed in this order in the axial direction of the motor shaft member 13. The input gear 31 faces the circuit unit 60 in the direction in which the rotation axis C1 extends.

The input gear 31 may face the mounting component mounted on the circuit board 61. In the example shown in FIGS. 1 and 2, the small-sized mounting component 62 mounted on the circuit board 61 and the input gear 31 face each other in the axial direction of the motor shaft member 13. The input gear 31 may face the circuit board 61.

As shown in FIGS. 1 and 2, the input gear 31 preferably does not face the large-sized mounting component 63 mounted on the circuit board 61 in the axial direction of the motor shaft member 13. In other words, the large-sized mounting component 63 is preferably disposed at a position not intersecting the rotation axis C1.

In the electric braking device 10, even when a height of the large-sized mounting component 63 from the surface of the circuit board 61 is changed, the large-sized mounting component 63 can be disposed as follows. That is, the large-sized mounting component 63 can be disposed even when the size of the large-sized mounting components 63 is changed.

Regarding the large-sized mounting component 63, it can be said that an end portion of the large-sized mounting component 63 farthest from the circuit board 61 is on the same plane as a plane passing through a point on the rotation axis C1 and orthogonal to the rotation axis C1. The point described above on the rotation axis C1 is, for example, a point between the input gear 31 and the circuit board 61. The point described above on the rotation axis C1 may be a point positioned between the input gear 31 and the circuit board 61 and close to the input gear 31, or may be a point positioned between the input gear 31 and the circuit board 61 and close to the circuit board 61. The point described above on the rotation axis C1 may be, for example, a point in the input gear 31. In other words, the large-sized mounting component 63 and the input gear 31 may face each other in the direction orthogonal to the rotation axis C1. The point described above on the rotation axis C1 may be, for example, a point in the motor shaft member 13. In other words, the large-sized mounting component 63 and the motor shaft member 13 may face each other in the direction orthogonal to the rotation axis C1. The point described above on the rotation axis C1 may be, for example, a point in the electric motor 12. In other words, the large-sized mounting component 63 and the electric motor 12 may face each other in the direction orthogonal to the rotation axis C1.

### Operations and Effects

Operations and effects of the embodiment will be described.

In the electric braking device 10, the output gear 33 is disposed so as to intersect the specific plane P2, so that the circuit unit 60 and the output gear 33 overlap each other in a direction of the rotation axis C1 that is a direction perpendicular to the virtual plane parallel to the circuit board 61. Due to this overlap, a size of the electric braking device 10 in the axial direction of the motor shaft member 13 is unlikely to increase. The output gear 33 is disposed so as to intersect the specific plane P2, so that the circuit unit 60 and the output gear 33 are unlikely to be disposed at positions separated from each other in, for example, a direction perpendicular to the surface of the circuit board 61. Therefore, in the direction perpendicular to the surface of the circuit board 61, the circuit unit 60 is unlikely to be disposed at a position separated from the electric motor 12. Accordingly, the size of the electric braking device 10 in the axial direction of the motor shaft member 13 is unlikely to increase.

In the electric braking device 10, the circuit unit 60 can be accommodated in the housing 11. Accordingly, the electric braking device 10 is less likely to be large in the axial direction of the motor shaft member 13 as compared with a case in which the circuit board 61 having the mounting components is accommodated in a case or the like separate from the housing 11 and attached to the outside of the housing 11.

In the electric braking device 10, the input gear 31 does not face the large-sized mounting component 63 disposed on the surface of the circuit board 61 facing the electric motor 12. Accordingly, it is possible to dispose the large-sized mounting component 63 while preventing an increase in the size of the electric braking device 10 in the axial direction of the motor shaft member 13.

In the electric braking device 10, the input gear 31 is disposed at the position shifted in the axial direction of the motor shaft member 13 with respect to the circuit board 61. Since the circuit unit 60 and the input gear 31 face each other in the axial direction of the motor shaft member 13, the input gear 31 is not disposed in a direction in which the surface of the circuit board 61 extends. Accordingly, it is possible to prevent the increase in the size of the electric braking device 10 in the direction in which the surface of the circuit board 61 extends. The direction in which the surface of the circuit board 61 extends corresponds to a direction orthogonal to the direction in which the rotation axis C1 extends.

### Modifications

The present embodiment can be modified and implemented as follows. The embodiment and the following modifications can be implemented in combination with each other within a technically consistent range.

In the above embodiment, the configuration is shown as an example in which the electric motor 12, the input gear 31, and the circuit board 61 are disposed in this order in the axial direction of the motor shaft member 13. The positional relationship among the electric motor 12, the input gear 31, and the circuit board 61 is not limited thereto. For example, a configuration as shown in FIG. 3 may be adopted.

FIG. 3 shows an electric braking device 110. The electric braking device 110 has a configuration in which an input gear 131, an electric motor 112, and a circuit board 161 are disposed in this order in a direction in which a rotation axis C11, which is a line along an axis of a motor shaft member 113, extends. FIG. 3 shows a small-sized mounting component 162 and a large-sized mounting component 163 mounted on the circuit board 161.

In such an electric braking device 110, the circuit board 161 and the electric motor 112 are also disposed such that a virtual plane parallel to the circuit board 161 intersects the rotation axis C11. FIG. 3 shows a virtual plane P11 that intersects the motor shaft member 113 among virtual planes parallel to the circuit board 161.

In such an electric braking device 110, an output gear 133 can also be disposed so as to intersect a specific plane P12 that is a virtual plane parallel to the circuit board 161 and passing through the circuit unit 160.

For example, FIG. 3 shows the output gear 133 disposed to intersect the specific plane P12. A surface of the output gear 133 orthogonal to the axis of the output shaft member is disposed parallel to the circuit board 161. An output axis C12, which is a line along the axis of the output shaft member, is orthogonal to the specific plane P12.

An example of a transmission mechanism 130 including the input gear 131 and the output gear 133 as shown in FIG. 3 includes an intermediate gear portion 132 in which a gear engaging with the input gear 131 and a gear engaging with the output gear 133 are coupled to each other by a shaft having a length in the axial direction of the motor shaft member 113. As in the example shown in FIG. 3, a length of the transmission mechanism 130 in an extending direction of the output axis C12 may be longer than a length of the electric motor 112.

In the above embodiment, an example is shown in which the specific plane P2 is a virtual plane parallel to the circuit board 61 and passing through the mounting components. Alternatively, as shown in FIG. 3, a virtual plane parallel to the surface of the circuit board 161 and passing through the circuit board 161 may be set as the specific plane P12. That is, as shown in FIG. 3, the output gear 133 and the circuit board 161 may be disposed on the specific plane P12. According to such a configuration, the circuit board 161 and the output gear 133 can be disposed side by side on the specific plane P12. Since the circuit board 161 and the output gear 133 can be disposed as described above, a degree of freedom in arranging components can be improved other than the circuit board and the output gear in the electric braking device.

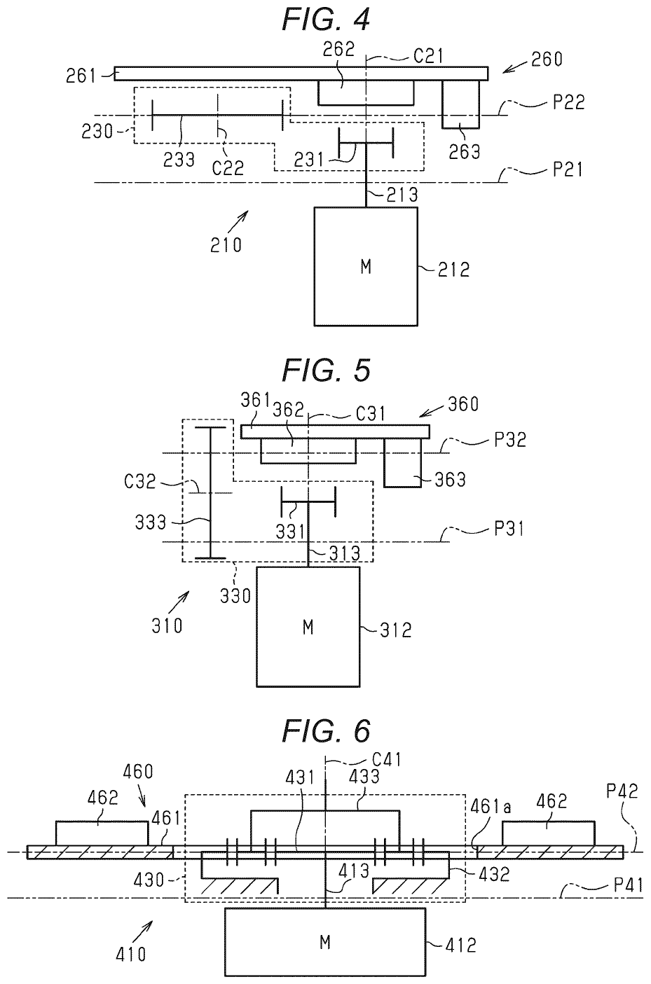

In the above embodiment, as shown in FIGS. 1 and 2, a configuration is shown as an example in which the output gear 33 and the circuit unit 60 do not face each other in the direction in which the rotation axis C1 extends. The positional relationship between the output gear and the circuit unit is not limited thereto. For example, a configuration as shown in FIG. 4 may be adopted.

FIG. 4 shows an electric braking device 210. As shown in FIG. 4, an output gear 233 of a transmission mechanism 230 may face a circuit unit 260 in a direction in which an output axis C22 extends. For example, the output gear 233 may face a circuit board 261 in the direction in which the output axis C22 extends. That is, the electric braking device 210 may have a configuration as follows. The circuit board 261 of the electric braking device 210 is expanded as compared with the circuit board 61 of the electric braking device 10, such that the circuit board 261 and the output gear 233 face each other in the direction in which the output axis C22, which is a line along an axis of a shaft member of the output gear 233, extends. In other words, in the electric braking device 210, the output gear 233 is disposed at a position shifted in an axial direction of a motor shaft member 213 with respect to the circuit board 261. In this modification, a substrate area can be increased as compared with the embodiment shown in FIGS. 1 and 2. A member different from the output gear 233 and the circuit unit 260 may be disposed between the output gear 233 and the circuit unit 260. In this modification, in order to hold the output shaft member on the output gear, a through hole may be provided in the circuit board 261, and the output shaft member passing through the through hole may be held by the housing.

In the electric braking device 210 shown in FIG. 4, the circuit board 261 and an electric motor 212 are also disposed such that a virtual plane parallel to the circuit board 261 intersects a rotation axis C21. FIG. 4 shows a virtual plane P21 that intersects the motor shaft member 213 among virtual planes parallel to the circuit board 261. An input gear 231 faces a small-sized mounting component 262 in the direction in which the rotation axis C21 extends.

In FIG. 4, a virtual plane that is parallel to the circuit board 261 and passes through a large-sized mounting component 263 having a height higher than that of the small-sized mounting component 262 is indicated as a specific plane P22. According to such an electric braking device 210, it is possible to ensure a space within the housing for making the circuit board 261 larger.

The transmission mechanism may include a mechanism in which an axis of the input gear and an axis of the output gear intersect each other. An example will be described with reference to FIG. 5.

FIG. 5 shows an electric braking device 310 including a transmission mechanism 330. The transmission mechanism 330 includes a bevel gear including an input gear 331 and an output gear 333. That is, in the electric braking device 310, a rotation axis C31 and an output axis C32 intersect each other. The rotation axis C31 and the output axis C32 may be orthogonal to each other as shown in FIG. 5. In the electric braking device 310, a positional relationship among an electric motor 312, the input gear 331, and a circuit unit 360 is common to that of the electric braking device 10 in the above-described embodiment. FIG. 5 shows a small-sized mounting component 362 and a large-sized mounting component 363 mounted on a circuit board 361.

In such an electric braking device 310, the circuit board 361 and the electric motor 312 are also disposed such that a virtual plane parallel to the circuit board 361 intersects the rotation axis C31. FIG. 5 shows a virtual plane P31 that intersects a motor shaft member 313 among virtual planes parallel to the circuit board 361.

In such an electric braking device 310, the output gear 333 can also be disposed so as to intersect with a specific plane P32 that is a virtual plane parallel to the circuit board 361 and passing through the circuit unit 360.

In the above modification, the transmission mechanism 330 including the bevel gear such that the rotation axis C31 and the output axis C32 are orthogonal to each other is shown as an example. The transmission mechanism may have a configuration such that the rotation axis C31 and the output axis C32 are at twisted positions. That is, the transmission mechanism may include a hypoid gear. The transmission mechanism may include a mechanism including a worm and a worm wheel.

The transmission mechanism may include a planetary gear mechanism. An example will be described with reference to FIG. 6.

FIG. 6 shows an electric braking device 410 including a transmission mechanism 430. The transmission mechanism 430 includes a planetary gear mechanism. Specifically, the transmission mechanism 430 includes an input gear 431 corresponding to a sun wheel. The transmission mechanism 430 includes an output gear 433. The output gear 433 corresponds to a planetary gear and a carrier. The transmission mechanism 430 includes a ring gear 432. The ring gear 432 is fixed.

As an example of the planetary gear mechanism, FIG. 6 shows a configuration in which an axis of a motor shaft member 413 and an axis of an output shaft member coupled to the carrier of the output gear 433 are on the same axis. That is, the axis of the output shaft member is disposed on a rotation axis C41 that is a line along the axis of the motor shaft member 413.

As shown in FIG. 6, the electric braking device 410 may include a circuit board 461 in which a through hole 461a is formed. The transmission mechanism 430 may be inserted into the through hole 461a.

In such an electric braking device 410, the circuit board 461 and an electric motor 412 are also disposed such that a virtual plane parallel to the circuit board 461 intersects the rotation axis C41. FIG. 6 shows a virtual plane P41 that intersects the motor shaft member 413 among virtual planes parallel to the circuit board 461.

In the electric braking device 410, the output gear 433 can also be disposed so as to intersect with a specific plane P42 that is a virtual plane parallel to the circuit board 461 and passing through a circuit unit 460.

In the configuration shown in FIG. 6, mounting components 462 are attached to a surface of the circuit board 461 opposite to a surface facing the electric motor 412.

In the configuration shown in FIG. 6, the input gear 431 is also disposed on the specific plane P42. That is, the input gear 431, the output gear 433, and the circuit board 461 are disposed so as to intersect the specific plane P42.

. In the above modification, a configuration is shown as an example in which the transmission mechanism 430 is inserted into the through hole 461a formed in the circuit board 461. Instead of the circuit board 461 in which the through hole 461a is formed, a circuit board divided into a plurality of pieces may be adopted. For example, all of the plurality of circuit boards are disposed on the same plane. An interval may be provided between the adjacent circuit boards. A transmission mechanism may be disposed between the adjacent circuit boards.

As the electric motor, a flat motor as shown in FIG. 6 may be adopted. An electric motor having the following configuration is referred to as the flat motor. The flat motor is flat in a direction along the axis of the motor shaft member. Specifically, a length of the electric motor in the direction along the axis of the motor shaft member is shortened. On the other hand, a length of the electric motor in the direction orthogonal to the axis of the motor shaft member is increased.

In the above embodiment, the transmission mechanism 30 has a configuration such that the intermediate gear 32 is interposed between the input gear 31 and the output gear 33. In the transmission mechanism, the input gear and the output gear may directly engage with each other.

In the above embodiment, an example in which the circuit unit 60 is disposed in the accommodating portion 19 in the housing 11 is shown. It is not essential that the circuit unit 60 be disposed in the housing 11.

In the above embodiment, a configuration is shown as an example in which the input gear 31 and the circuit unit 60 face each other in the axial direction of the motor shaft member 13. A member different from the input gear 31 and the circuit unit 60 may be disposed between the input gear 31 and the circuit unit 60.

In the above embodiment, a configuration is shown as an example in which the input gear 31 and the circuit unit 60 face each other in the axial direction of the motor shaft member 13. That is, the configuration is shown as an example in which the input gear 31 is disposed at a position shifted in the axial direction of the motor shaft member 13 with respect to the circuit board 61. It is not essential that the input gear 31 and the circuit unit 60 face each other. Further, it is not essential that the motor shaft member 13 and the circuit unit 60 face each other. Regarding the positional relationship among the circuit board, the electric motor, and the input gear in the electric braking device, the circuit board 61 and the electric motor 12 may be disposed such that the virtual plane parallel to the circuit board 61 intersects the rotation axis C1.

In the above embodiment, as an example in which the rotation axis C1 and the circuit unit 60 intersect each other, a configuration is shown in which the rotation axis C1 and the circuit board 61 are orthogonal to each other. The rotation axis C1 and the circuit board 61 may obliquely intersect with each other.

1. An electric braking device comprising:
an electric motor configured to rotate a motor shaft member;
an actuator unit configured to move a friction material in response to rotation of the motor shaft member in the electric motor, and generate a braking force on a wheel of a vehicle by pressing the friction material against a rotary body that rotates integrally with the wheel;
a transmission mechanism configured to transmit a rotary motion of the motor shaft member to the actuator unit, and including an input gear configured to input the rotation of the motor shaft member, and an output gear configured to rotate in response to rotation of the input gear and transmit the rotation to the actuator unit; and
a circuit unit configured to control the electric motor, and including a circuit board and a mounting component mounted on the circuit board, wherein
the circuit board and the electric motor are disposed such that a virtual plane parallel to the circuit board intersects an axial direction of the motor shaft member, and
the output gear is disposed to intersect a specific plane which is a plane that passes through the circuit unit among the virtual planes.

2. The electric braking device according to claim 1, wherein the output gear and the circuit board are disposed such that a surface of the output gear orthogonal to an axial direction of a shaft member of the output gear is parallel to the circuit board.

3. The electric braking device according to claim 2, wherein
the specific plane passes through the mounting component of the circuit unit, and
the output gear is disposed at a position shifted in the axial direction of the motor shaft member with respect to the circuit board.

4. The electric braking device according to claim 3, wherein the circuit board is disposed to face the output gear.

5. The electric braking device according to claim 2, wherein the specific plane passes through the circuit board of the circuit unit.

6. The electric braking device according to claim 5, wherein the input gear is disposed at a position shifted in the axial direction of the motor shaft member with respect to the circuit board, and the circuit board is disposed to face the input gear.

7. The electric braking device according to claim 4, wherein the input gear is disposed at a position shifted in the axial direction of the motor shaft member with respect to the circuit board, and the circuit board is disposed to face the input gear.

8. The electric braking device according to claim 3, wherein the input gear is disposed at a position shifted in the axial direction of the motor shaft member with respect to the circuit board, and the circuit board is disposed to face the input gear.

9. The electric braking device according to claim 2, wherein the input gear is disposed at a position shifted in the axial direction of the motor shaft member with respect to the circuit board, and the circuit board is disposed to face the input gear.
